(19) United States
(12) Patent Application Publication
(10) Pub. No.: US 2015/0104001 A1
(43) Pub. Date: Apr. 16, 2015

(54) METHOD AND APPARATUS FOR VECTORING ADSL2 LINES

(71) Applicant: Ikanos Communications, Inc., Fremont, CA (US)

(72) Inventors: Murli Mohan RAO, Fremont, CA (US); Christophe SERVAES, Guttenberg, NJ (US)

(21) Appl. No.: 14/511,655

(22) Filed: Oct. 10, 2014

Related U.S. Application Data
(60) Provisional application No. 61/889,393, filed on Oct. 10, 2013.

(51) Int. Cl. H04B 3/32; H04M 3/00; H04L 5/02

(52) U.S. Cl. CPC H04B 3/32; H04L 5/023; H04M 3/005
USPC 379/406.06

(57) ABSTRACT

The present invention relates to methods and apparatuses for extending the benefits of vectoring technology to xDSL systems including disparate types of xDSL lines. In embodiments, the invention includes a scheme to match the symbol frequencies of ADSL2 and VDSL2 lines, to then enable vectoring of ADSL2 FEXT into VDSL2 lines.

### CROSS REFERENCE TO RELATED APPLICATIONS

This application claims the benefit under 35 USC 119(e) of prior co-pending U.S. Provisional Patent Application No. 61/889,393, filed Oct. 10, 2013, the disclosure of which is hereby incorporated by reference in its entirety.

### FIELD OF THE INVENTION

The present invention relates to data communications, and more particularly to methods and apparatuses for enabling vectoring technologies to be extended in xDSL systems including modems that do not support vectoring.

### BACKGROUND OF THE INVENTION

Vectoring technology (see, e.g. ITU-T G.993.5) employs the coordination of line signals on multiple VDSL2 transceivers to achieve Far-End Cross Talk (FEXT) cancellation within a vectored xDSL system (the term “xDSL” refers to various existing and future DSL standards such as ADSL, ADSL2, VDSL, VDSL2, etc.). This performance improvement relies on some coordination of all lines within the system, especially the symbol frequency. If an xDSL system includes legacy ADSL2 lines (see, e.g. ITU-T G.992.3) as well as VDSL2 lines, downstream vectoring performance in the VDSL2 lines is adversely affected, because of the lack of coordination between these lines and the VDSL2 lines that is required for vectoring. What is needed, therefore, are techniques for addressing these and other problems.

### SUMMARY OF THE INVENTION

The present invention relates to methods and apparatuses for extending the benefits of vectoring technology to xDSL systems including disparate types of xDSL lines. In embodiments, the invention includes a scheme to match the symbol frequencies of ADSL2 and VDSL2 lines, to then enable vectoring of ADSL2 FEXT into VDSL2 lines.

In accordance with these and other aspects, a method for managing communications in an xDSL system having one or more lines coupled to vectoring transceivers that support vectoring and one or more lines coupled to non-vectoring transceivers that do not support vectoring according to embodiments of the invention includes causing a symbol frequency of the vectoring transceivers to match a symbol frequency of the non-vectoring transceivers.

In further accordance of these and other aspects, a central office (CO) apparatus in an xDSL system according to embodiments of the invention includes vectoring transceivers that support vectoring coupled to one or more downstream lines, non-vectoring transceivers that do not support vectoring coupled to one or more other downstream lines, and a central controller that causes a symbol frequency of the vectoring transceivers to match a symbol frequency of the non-vectoring transceivers.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating an example xDSL system according to embodiments of the invention;

FIG. 2 is a diagram illustrating ADSL2 and VDSL2 bandplans that can be used in a xDSL system such as that shown in FIG. 1; and

FIG. 3 is a block diagram illustrating components for implementing an example CO in an xDSL system according to embodiments of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

According to some aspects of the invention, the present inventors recognize that G.vector VDSL2 performance can be severely impacted in downstream ADSL2 frequencies if there are legacy ADSL2 lines in the same system as the VDSL2 lines. The present inventors further recognize that ADSL2 and VDSL2 lines typically use different symbol frequencies, which makes cancellation of FEXT from legacy ADSL2 lines into VDSL2 lines impractical.

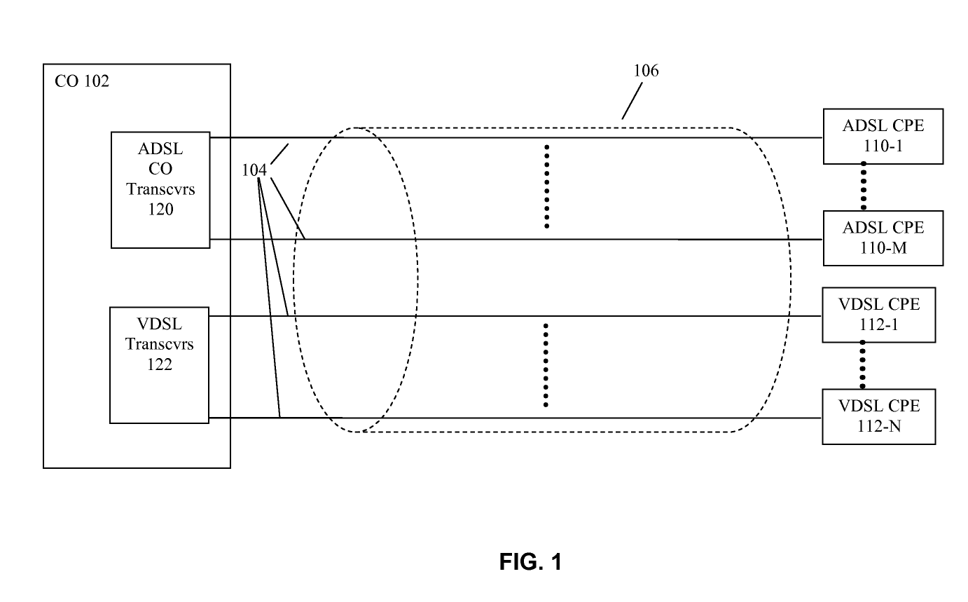

FIG. 1 illustrates an example system according to embodiments of the invention.

As shown, bundle 106 includes wire pairs 104, certain of which wire pairs 104 are coupled between M CPE transceivers 110 that do not support vectoring (e.g. ADSL2 compatible modems) and corresponding CO transceivers (e.g. ADSL2 compatible modems) 120, while other pairs 104 are coupled between N CPE transceivers 112 that do support vectoring (e.g. VDSL2 compatible modems) and corresponding CO transceivers 122 (e.g. VDSL2 compatible modems). Given that portions of the wire pairs 104 to these different types of CPE modems 110, 112 can exist in the same bundle 106, crosstalk (e.g. FEXT) between these different types of lines exists, which leads to a reduction in performance.

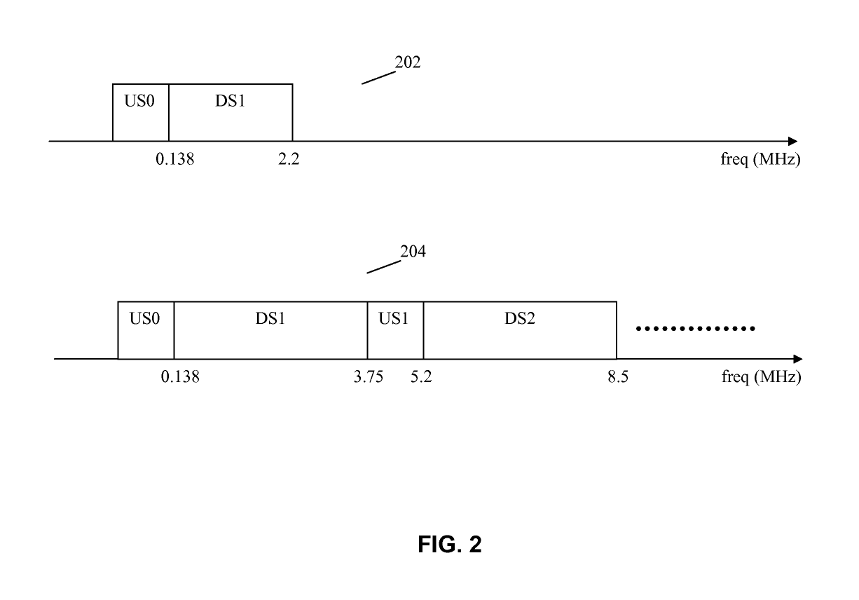

For example, as shown in FIG. 2, ADSL2 modems 110, 120 can communicate with each other using a bandplan 202, while VDSL2 modems 112, 122 can communicate with each other using a bandplan 204. As can be seen, bandplans 202 and 204 overlap in the range of frequencies up to the limit of the ADSL2 bandplan 202 (either 1.1 MHz or 2.2 MHz). As such FEXT coupling from modems 110, 120 will exist in communications between modems 112, 122 in these frequencies.

Vectoring technologies can improve performance due to FEXT between lines having modems that support such technologies. However, in cases such as that shown in FIG. 1, such vectoring technologies cannot conventionally account for FEXT due to lines coupled to modems that do not support vectoring technologies such as modems 110.

According to certain aspects, the present invention improves performance in such cases by causing the symbol frequency in communications between vectoring CO modems 120 and CPE modems 112 to match the symbol frequency in communications between non-vectoring CO modems 120 and CPE modems 110. This would then enable the CO 102 to perform vectoring for modems 122 at the common symbol frequency, making FEXT cancellation from ADSL2 lines into VDSL2 lines viable.

In one example embodiment, the invention achieves the matching symbol frequencies by changing the cyclic extension of the symbols communicated to CPE modems 122 of the g.vector system, so as to cause the VDSL2 symbol size to change, and thus the symbol frequency to match the ADSL2 symbol frequency.

Per section 8.8.3 of g.992.3, the ADSL2 symbol frequency is 4.059 KHz.

Meanwhile, per section 10.4.4 of g.993.2, the VDSL2 cyclic extension is controlled by the parameter m in the following relationship:

L_{CE}=(L_{CP}−β)=m×N/32(m=[2:16]).

Where L_{CE} is the cyclic extension in terms of samples.

In a typical VDSL2 system, Nis set to 4096, and m is set to 5, which yields a cyclic extension of 640 samples and a 4 KHz symbol rate.

The TABLE 1 below shows how, while keeping N set to 4096 and changing the values of m, the cyclic extension, and thus the symbol rate, are changed.

TABLE 1

| | CE | |
|---|---|---|
| M | (samples) | Symbol rate (KHz) |
| 2 | 256 | 4.1818 |
| 3 | 384 | 4.1194 |
| 4 | 512 | 4.0588 |
| 5 | 640 | 4 |
| 6 | 768 | 3.9429 |
| 7 | 896 | 3.8873 |
| 8 | 1024 | 3.8333 |
| 9 | 1152 | 3.7808 |
| 10 | 1280 | 3.7297 |
| 11 | 1408 | 3.68 |
| 12 | 1536 | 3.6316 |
| 13 | 1664 | 3.5844 |
| 14 | 1792 | 3.5385 |
| 15 | 1920 | 3.4937 |
| 16 | 2048 | 3.45 |

It can be readily seen from the above table that using m=4, (resulting in a 512 sample CE), while keeping N set to 4096, would result in a VDSL2 symbol frequency of 4.059 KHz, which matches the ADSL2 symbol rate. The choice of m can be controlled by CO 102 and in embodiments is communicated to modems 112 during O-Signature and O-PRM.

By matching the symbol rates and synchronizing the symbols at the CO modems 120 and 122 for communications with both the VDSL2 modems 112 and ADSL2 modems 110, respectively, FEXT coupling from the ADSL2 lines onto the VDSL2 modems can be effectively characterized and canceled.

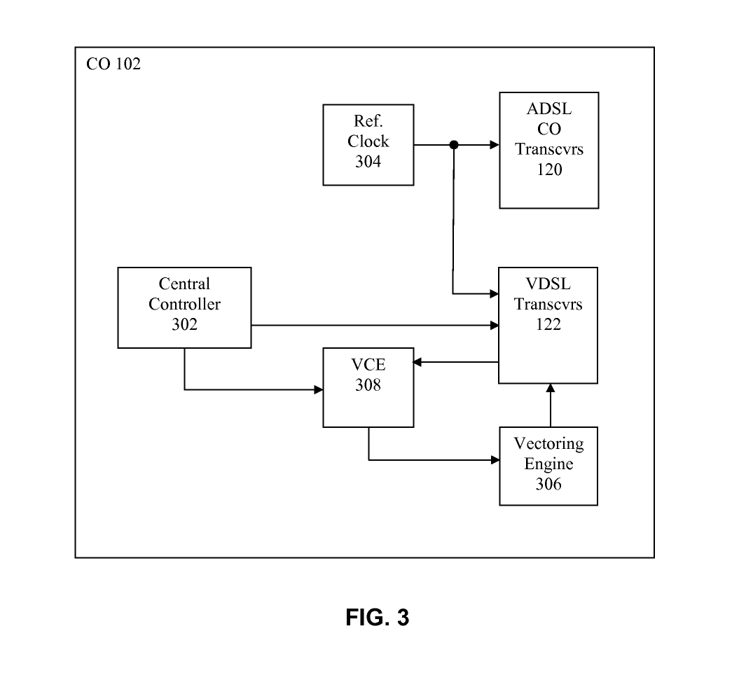

A block diagram illustrating an example CO 102 for implementing aspects of the present invention is shown in FIG. 3. As shown, in addition to components illustrated in FIG. 1, CO 102 includes central controller 302, reference clock 304, vectoring engine 306 and vector control entity (VCE) 308.

Central controller 302, vectoring engine 306 and VCE 308 can be implemented by processors, chipsets, firmware, software, etc. such as NodeScale Vectoring products provided by Ikanos Communications, Inc. Those skilled in the art will be able to understand how to adapt these and other similar commercially available products after being taught by the present examples.

Meanwhile, CO transceivers 120 and 122 include conventional processors, chipsets, firmware, software, etc. that implement communication services such as those defined by ADSL2, and VDSL2, respectively, and using band plans such as 202 and 204, respectively. Further details thereof will be omitted for sake of clarity of the invention. It should be noted that non-vectoring CO transceivers 120 and vectoring CO transceivers 122 are shown separately for ease of illustration; however, it is possible that the same CO transceivers can include functionality for communicating both with non-vectoring CPE transceivers 110 and vectoring CPE transceivers 112, depending on the capabilities of the CPE modem connected at the downstream end.

Reference clock 304 is shown separately to emphasize that transceivers 120, 122 both use the same reference clock. As a result, when both of them are configured by central controller 302 as described above to have the same symbol frequency, they will also share the same symbol boundaries, making vectoring of the ADLS2 lines possible.

According to embodiments of the invention, in operation of a system such as that shown in FIG. 3, central controller 302 will configure CO transceivers 120 to perform ADSL2 communications using the band plan 202 and configure transceivers 122 to perform VDSL2 communications using the band plan 204. Central controller 302 further configures transceivers 122 to use a symbol frequency that matches the ADSL2 frequency. As described above, in embodiments this includes causing transceivers 122 to use m=4, (resulting in a 512 sample CE), while keeping N set to 4096, which results in a VDSL2 symbol frequency of 4.059 KHz, the same as the ADSL2 symbol rate used by transceivers 120. In these and other embodiments, transceivers 122 communicate the choice of m to modems 112 during O-Signature and O-PRM.

Once the down-stream symbols are aligned to a common symbol frequency for both ADSL2 and VDSL2 lines 104, controller 102 causes the VCE 308 to start learning down-stream coefficients for FEXT coupling of the ADSL2 lines into the VDSL2 lines. In embodiments, this includes controller 102 causing the transceivers 120 to transmit data-symbols during the VDSL2 down-stream sync-symbol slots transmitted by transceivers 122 for learning VDSL2 FEXT coefficients in the conventional manner. According to embodiments of the invention, VCE 308 further learns the ADSL2 down-stream FEXT coefficients by correlating the VDSL2 down-stream sync-symbol errors with the corresponding down-stream ADSL2 Show-time symbols using techniques known to those skilled in the art.

When FEXT coefficients have been learned and programmed into the precoder used by vectoring engine 306 as set forth above, VDSL2 communications by transceivers 122 can be performed in the conventional manner, while benefitting from the additional performance improvements yielded by vectoring of the ADSL2 lines according to the invention.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method for managing communications in an xDSL system having one or more lines coupled to vectoring transceivers that support vectoring and one or more lines coupled to non-vectoring transceivers that do not support vectoring, comprising:
causing a symbol frequency of the vectoring transceivers to match a symbol frequency of the non-vectoring transceivers.

2. A method according to claim 1, wherein the vectoring transceivers are VDSL2 transceivers and wherein the non-vectoring transceivers are ADSL2 transceivers.

3. A method according to claim 2, wherein causing the symbol frequencies to match includes adjusting the VDSL2 cyclic extension of the VDSL2 transceivers.

4. A method according to claim 1, further comprising learning FEXT coefficients for crosstalk coupling into the lines coupled to vectoring transceivers from the lines coupled to non-vectoring transceivers.

5. A method according to claim 1, further comprising vectoring of crosstalk coupling into the lines coupled to vectoring transceivers from the lines coupled to non-vectoring transceivers.

6. A method according to claim 4, further comprising vectoring of crosstalk coupling into the lines coupled to vectoring transceivers from the lines coupled to non-vectoring transceivers using the learned FEXT coefficients.

7. A central office (CO) apparatus in an xDSL system comprising:
vectoring transceivers that support vectoring coupled to one or more downstream lines;
non-vectoring transceivers that do not support vectoring coupled to one or more other downstream lines; and
a central controller that causes a symbol frequency of the vectoring transceivers to match a symbol frequency of the non-vectoring transceivers.

8. A CO apparatus according to claim 7, wherein the vectoring transceivers are VDSL2 transceivers and wherein the non-vectoring transceivers are ADSL2 transceivers.

9. A CO apparatus according to claim 8, wherein the central controller causes the symbol frequencies to match by adjusting the VDSL2 cyclic extension of the VDSL2 transceivers.

10. A CO apparatus according to claim 7, further comprising a VCE that learns FEXT coefficients for crosstalk coupling into the lines coupled to vectoring transceivers from the lines coupled to non-vectoring transceivers.

11. A CO apparatus according to claim 7, further comprising a vectoring engine that performs vectoring of crosstalk coupling into the lines coupled to vectoring transceivers from the lines coupled to non-vectoring transceivers.

12. A CO apparatus according to claim 10, further comprising a vectoring engine that performs vectoring of crosstalk coupling into the lines coupled to vectoring transceivers from the lines coupled to non-vectoring transceivers using the learned FEXT coefficients.
